(19) United States
(12) Patent Application Publication
(10) Pub. No.: US 2015/0285907 A1
(43) Pub. Date: Oct. 8, 2015

(54) TERAHERTZ SCREENING APPARATUS FOR DETECTION OF CONCEALED WEAPONS

(71) Applicant: Farrokh Mohamadi, Irvine, CA (US)

(72) Inventor: Farrokh Mohamadi, Irvine, CA (US)

(21) Appl. No.: 14/270,003

(22) Filed: May 5, 2014

Related U.S. Application Data
(60) Provisional application No. 61/819,444, filed on May 3, 2013.

(51) Int. Cl. G01S 13/88; H01Q 3/26; G01S 7/02; G01S 13/89; G01S 13/02

(52) U.S. Cl. CPC G01S 13/887; G01S 13/89; G01S 13/0209; G01S 7/02; H01Q 3/26

(57) ABSTRACT

A system for screening, where a subject walks through a scanning area (for example, between two panels) provides readily deployable detectors for places where such detection may not normally be in use or available—such as public gatherings, voting lines, entrances of stadiums, religious gathering places, banks, and markets. High resolution imaging is achieved through implementation of central feed network elements, left-hand circularly polarized (LHCP) and right-hand circularly polarized (RHCP) arrays, and terahertz radar, as well as core signal processing at 5 GHz using ultra wideband (UWB) sensors. Terahertz technology provides screening of person borne improvised explosive devices (IED) including classification of explosive. A terahertz system provides high resolution RF imaging through deployment of a walk-in screener that can be unobtrusively or covertly installed.

### CROSS REFERENCE TO RELATED APPLICATIONS

This application claims the benefit of priority from U.S. Provisional Patent Application No. 61/819,444, filed May 3, 2013, which is incorporated by reference.

### BACKGROUND

1. Field of the Invention

The present invention relates generally to radar imaging systems and, more particularly, to security screening of individuals, using ultra wideband radar systems integrated with wafer scale antenna arrays operating at terahertz frequencies for enhanced image resolution.

2. Related Art

An important security issue for protection of individuals in public places—such as public gatherings, voting lines, entrances of stadiums, government agency offices, religious gathering places, banks, markets, airports, schools, and government facilities, for example—is detection of hidden objects, e.g., objects such as weapons or improvised explosive devices (IED) that may be carried by a person and concealed, for example, underneath or within clothing or in luggage or other hand-carried items. Many of the entities responsible for public safety in such places, such as government agencies, may find an advanced portable imaging technology with automated threat recognition for screening individuals to be highly desirable for example, an easy-to-set-up apparatus requiring less than 30 minutes installation time to be ready to be used anywhere for detecting IEDs on a person. X-ray technology has been used, for example, for airport screening but presents a number of issues, such as cumulative over exposure to radiation for airport and airline personnel and concerns over personal privacy, that have led to a search for other technologies and methods for addressing these security issues. Conventional terahertz radio frequency (RF) systems for scanning an object have device size limitations (e.g., they are typically far too large) due to their employment of optical-mechanical techniques that require such bulky elements as multiple lens arrangements, mechanical scanners, focal antennas, and choppers to create pulses at such high frequencies.

Of special interest is a screening system that is non-invasive of privacy and that can be readily deployed around the entrances of stadiums, government agency offices, banks, voting lines, religious gathering places, markets, public gatherings, for example, or other targets that may be viewed by perpetrators as high impact targets for their asset values or ability to focus media attention.

### BRIEF DESCRIPTION OF THE DRAWINGS

FIG. 1 is a system block diagram illustrating a radar sensor in accordance with an embodiment of the present invention.

FIGS. 2A and 2B are system block diagrams illustrating alternative implementations of radar transmitters for the sensor of FIG. 1, in accordance with one or more embodiments.

FIG. 3 is a system block diagram illustrating a radar receiver for the sensor of FIG. 1, in accordance with an embodiment.

FIGS. 4A and 4B are physical illustrations of deployment of a wafer scale sensor system, in accordance with one or more embodiments.

FIG. 5 is a circuit block diagram showing an example of an implementation for a terahertz wafer scale sensor system, in accordance with one or more embodiments.

FIG. 6 is an illustration of an actual scan of a mannequin simulating a person with a backpack and carrying a concealed metal knife in a pocket, in accordance with one or more embodiments.

FIGS. 7A and 7B are illustrations of a mannequin simulating a person carrying a gun and knife, concealed in FIG. 7A and visible in FIG. 7B; and FIG. 7C is an illustration of a scanned image showing the gun and knife, in accordance with one or more embodiments.

FIG. 8A is an illustration of a 24-channel integrated radar module for a scalable array for V-band or W-band to terahertz array implementation, in accordance with one or more embodiments; and FIG. 8B is an illustration of a channel line card as seen in the illustration of FIG. 8A, in accordance with one or more embodiments

Embodiments of the present disclosure and their advantages are best understood by referring to the detailed description that follows. It should be appreciated that like reference numerals are used to identify like elements illustrated in one or more of the figures, in which the showings therein are for purposes of illustrating the embodiments and not for purposes of limiting them.

### DETAILED DESCRIPTION

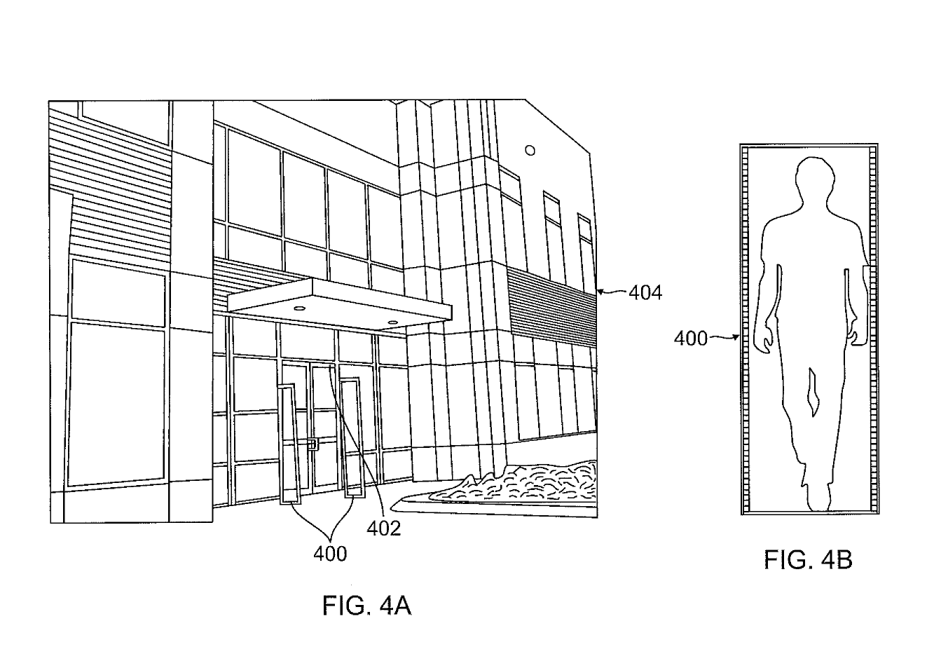

Methods and systems are disclosed that address the need for readily deployable detectors for places where such detection may not normally be in use or available—such as public gatherings, voting lines, entrances of stadiums, religious gathering places, banks, and markets, for example. Various embodiments address the need for a screening system that is non-invasive of privacy and that can be readily deployed around the entrances of stadiums, government agency offices, banks, voting lines, religious gathering places, markets, public gatherings, for example, or other targets of criminal perpetrators. Various embodiments address the need for an advanced portable (e.g., of a compact size easily manageable by one person) imaging technology with automated threat recognition for screening individuals that can be easy-to-set-up, requiring less than 30 minutes installation time to be ready to be used anywhere for detecting IEDs on a person. Various embodiments address the need for a fully integrated, solid state solution that can be unobtrusively placed, for example, in the entrance of a door in security sensitive buildings or in a passage area to a secured area such as airports, stadiums, banks, government offices, polling lines, or markets. The unique portable system can also be placed inside an office's dry wall as illustrated in FIG. 4B.

Various embodiments can implement a system for screening, where the subject walks through a scanning area (for example, between two panels) with a footprint size of about 3 ft. by 3 ft. (horizontally) by about 8 ft. (vertically). Embodiments can eliminate the need for removing a jacket, backpack, or shoes. One of the two panels may be used to capture front, back, and side RF images of the subject by deploying the terahertz (e.g., about 300-3000 GHz frequency bands) RF system. The scanned and captured images from the back, sides and front of the subject can show the potential threats and their classification and can be viewed (e.g., on a laptop display) at a remote location or in the vicinity of the scanning area. The laptop (for example) may communicate with the scanning unit through a secure WiFi or 4G connection, which can also be connected to a remote command and monitoring station.

Various embodiments may be achieved through implementation of central feed network 64×64 (4098) elements, left-hand circularly polarized (LHCP) and right-hand circularly polarized (RHCP) passive arrays, and a terahertz radar, as well as a core signal processing at 5 GHz ultra wideband (UWB) sensor. Terahertz technology may provide for screening person borne IEDs including classification of explosive. Deployment of the walk-in screener terahertz system may provide the highest resolution RF imaging, may be portable and easy to install, and may have the smallest footprint, whether used overtly or covertly, among RF systems. The screener, according to one or more embodiments, can address objectives of preventing mass casualties and deterring threats that may be induced by perpetrator-perceived outcome of high media impact.

One or more embodiments may include implementation of a fully integrated FCC compliant screener using miniaturized wafer scale antenna arrays to form spatial power combining and narrow beam forming. One or more embodiments may include implementation of an array of polarized miniature wafer scale antenna elements with material differentiation and classification capabilities. One or more embodiments may include implementation of distributed signal processors to process multiplexing transmitted impulse signals and synchronized received reflections for a body subject to the scan. One or more embodiments may include stick diagram presentation (addressing privacy concerns and issues) of visual screen and audio alarms from scanned data. One or more embodiments may include an order of magnitude improvement in size-weight-and-power (SWAP) compared to the existing x-ray and millimeter-wave scanners in the airports. One or more embodiments may include an order of magnitude improvement in set up time at any location compared to existing systems. One or more embodiments may include an order of magnitude improvement in detecting small objects. One or more embodiments may include capability to identify the explosive type, if explosives are found. One or more embodiments may include extended range application using active arrays (e.g., left-hand circularly polarized (LHCP) and right-hand circularly polarized (RHCP) active arrays). One or more embodiments may include substantially flat absorption response over a terahertz (THz) frequency range (e.g., about 300-3000 GHz) and high absorption, ultra sensitive receiver. One or more embodiments may include substantially flat transmission response over a THz frequency range and an ultra low-reflective collimator array.

Various embodiments may incorporate teachings from U.S. Patent Publication No. 2012/0001674 published Jan. 5, 2012, entitled “Wafer Scale Spatial Power Combiner”; U.S. Patent Publication No. 2013/0248656 published Sep. 26, 2013, entitled “Integrated Wafer Scale, High Data Rate, Wireless Repeater Placed On Fixed Or Mobile Elevated Platforms”; and U.S. Patent Publication No. 2013/0307716 published Nov. 21, 2013, entitled “Integrated Ultra Wideband, Wafer Scale, RHCP-LHCP Arrays”, all of which are incorporated by reference.

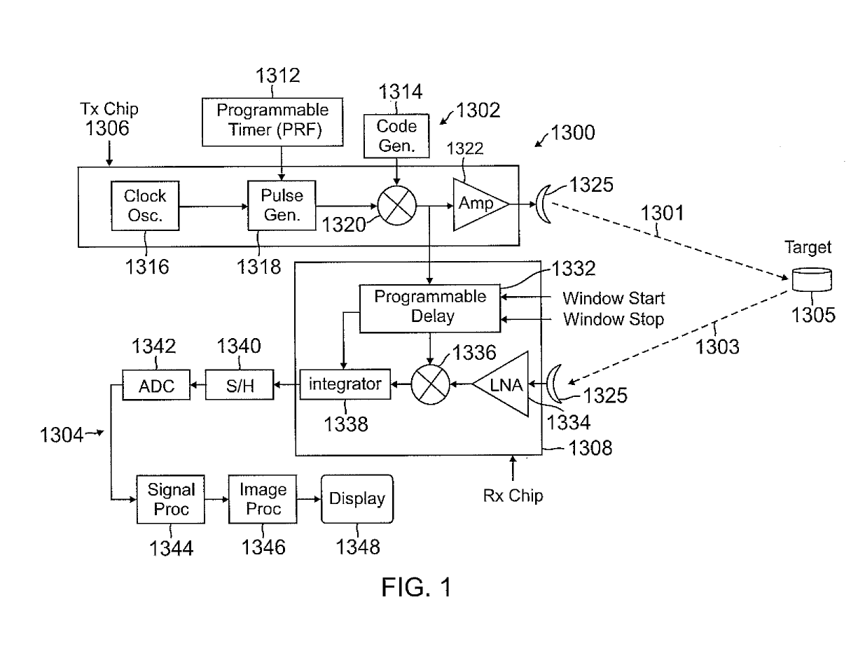

FIG. 1 is a general block diagram illustrating transmit and receive functions of a radar sensor 1300 in accordance with an embodiment. The impulse radar 1300 can transmit narrow RF-pulses at a certain pulse repetition frequency (PRF) and perform the required signal processing on reflected responses to construct a digitized representation of the target 1305 (e.g., a person being screened). In the receiver 1304, amplitude and delay information may be extracted and digitally processed.

Radar sensor 1300 may include an impulse radar transmitter 1302 that may transmit (TX) and receive (RX) radar signals using beam forming and power combining to produce, for example, narrow radio frequency (RF) pulses at a specific pulse repetition frequency (PRF). For example, the transmitter of radar sensor 1300 may emit RF radiation 1301 in the form of rapid wideband (narrow width) radar pulses at a chosen pulse repetition frequency (PRF) in the 1-10 GHz band. The pulses can penetrate many different types of material including, for example, clothing, biological tissue, soil, glass, wood, concrete, dry wall, and bricks with varying attenuation constant. The radar sensor 1300 may, for example, transmit Gaussian pulses as short as a few pico-seconds wide with center frequency in the 1-10 GHz band. By choosing a PRF in the range of 10-100 MHz, for example, and appropriate average transmitter power, a surveillance range of approximately 5-50 feet can generally be achieved. Transmitter 1302 may employ a wafer scale antenna and wafer scale beam forming as disclosed in U.S. Pat. No. 7,312,763, issued Dec. 25, 2007, to Mohamadi and U.S. Pat. No. 7,548,205, issued Jun. 16, 2009, to Mohamadi and virtual beam forming as disclosed in U.S. Pat. No. 8,237,604, issued Aug. 7, 2012, to Mohamadi et al., all of which are incorporated by reference.

Radar sensor 1300 may include a radar receiver 1304 that performs the required signal processing on a reflected response (e.g., reflected pulses 1303) to construct a digitized representation of the target 1305 (e.g., a buried IED). In the receiver 1304, amplitude and delay information may be extracted and digitally processed. As shown in FIG. 1, many of the transmitter 1302 functions may be implemented on a transmitter chip 1306 and many of the receiver 1304 functions may be implemented on a receiver chip 1308.

As shown in FIG. 1, radar sensor 1300 may include modules for performing the functions, including: programmable timer 1312 for establishing the PRF; code generator 1314 for providing modulations to the signal 1301; clock oscillator 1316 for providing the RF carrier frequency signal; pulse generator 1318 for forming (or generating) narrow radar pulses based on timing from programmable timer 1312; multiplier 1320 for combining the generated radar pulses with the output of code generator 1314; power amplifier 1322 for amplifying the pulse signal and feeding it to antenna 1325, which may a wafer scale, beam forming antenna as described above. Although two antennas 1325 are shown in FIG. 1 for clarity of illustration, use of a circulator (not shown) may enable use of a single antenna 1325 for both transmit and receive. Antenna 1325 may include an active array antenna implemented using wafer scale antenna module technology. Wafer scale antenna modules (WSAM) are disclosed by U.S. Pat. No. 7,884,757, issued Feb. 8, 2011, to Mohamadi et al. and U.S. Pat. No. 7,830,989, issued Nov. 9, 2010 to Mohamadi, both of which are incorporated by reference.

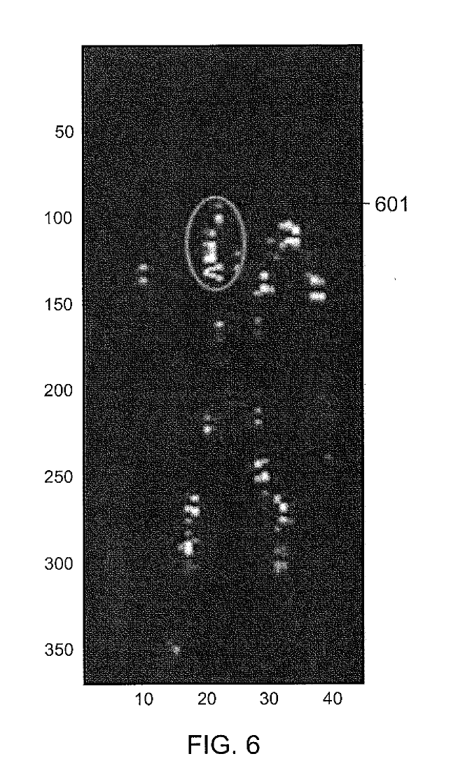

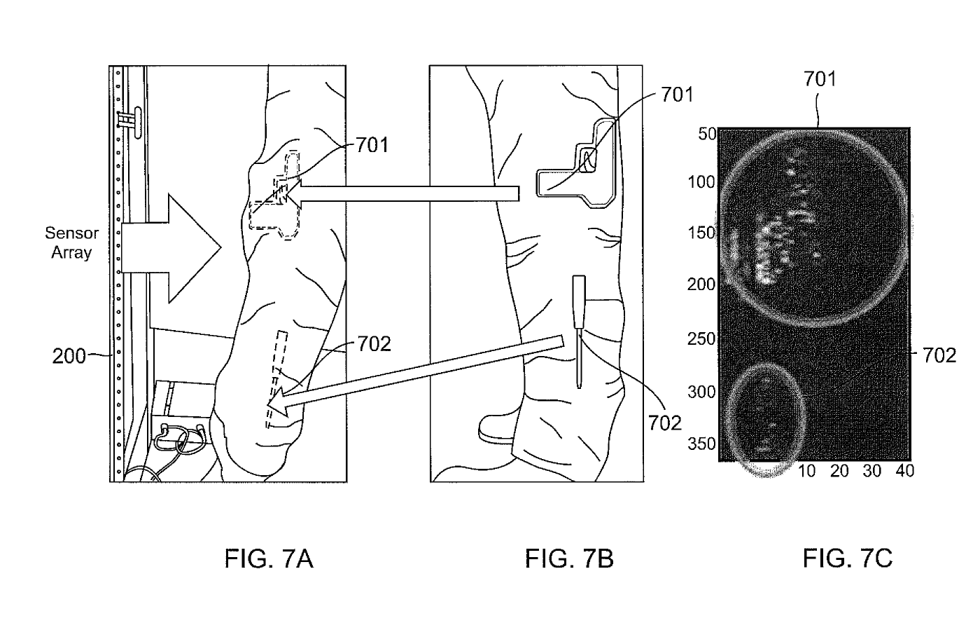

Radar sensor 1300, as shown in FIG. 1, may further include modules for performing functions including: programmable delay timer 1332, coordinated with the transmitted signal 1301, as indicated by the arrow between transmitter chip 1306 and receiver chip 1308, for providing timing, e.g., window start and window stop, for receiving reflected pulses 1303; a low noise amplifier 1334 for receiving the reflected pulses 1303; multiplier 1336 for combining the received reflected pulses 1303 and the window delay from programmable delay timer 1332; integrator 1338; sample and hold 1340, analog to digital converter 1342; signal processor 1344 (e.g., a digital signal processor or DSP); image processor 1346; and display 1348. Display 1348 may provide images as shown for example in FIG. 6 or FIG. 7C.

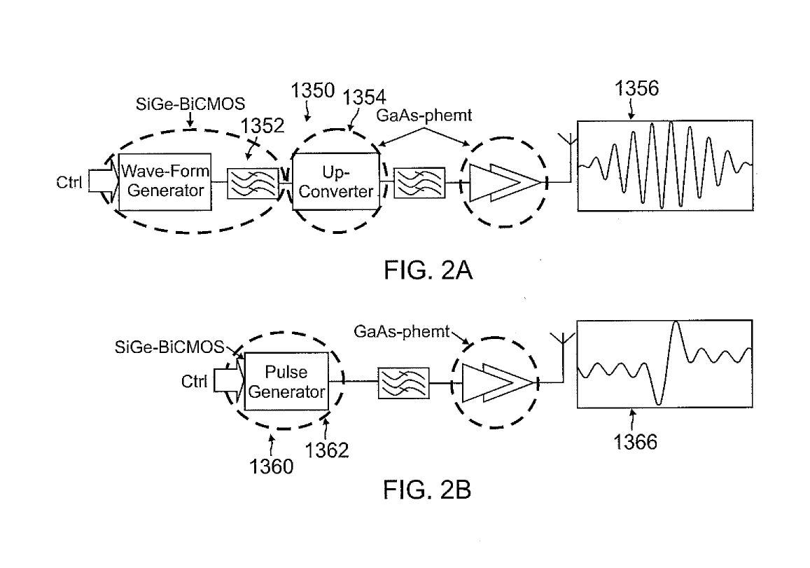

FIGS. 2A and 2B illustrate alternative implementations of radar transmitters (e.g., radar transmitter 1302) for radar sensor 1300 of FIG. 1, in accordance with one or more embodiments. In one implementation 1350 strategy, shown in FIG. 2A, the pulse shaping 1352 is performed in the intermediate frequency (IF) bands, and the resulting pulse is up-converted 1354 to RF frequencies resulting in a “carrier-inclusive” UWB-pulse or burst 1356. This strategy may provide versatility in defining carrier frequency for transmission with more flexibility in wave-pulse form definition.

In another implementation 1360 strategy, shown in FIG. 2B, the pulse generation 1362 is performed in the RF bands resulting in a “carrier-less” UWB-pulse 1366. This strategy may use less complex circuitry and may have lower power dissipation.

As indicated in FIGS. 2A and 2B, either implementation may employ indium phosphide high electron mobility transistor (HEMT), silicon complementary metal oxide semiconductor (CMOS) or silicon-germanium (SiGe) bipolar-complementary metal oxide semiconductor (BiCMOS) technologies. Also as indicated in FIGS. 2A and 2B, the up-converter and power amplifier stages of either implementation may employ gallium-arsenide (GaAs) pseudomorphic high electron mobility transistor (pHEMT) technologies.

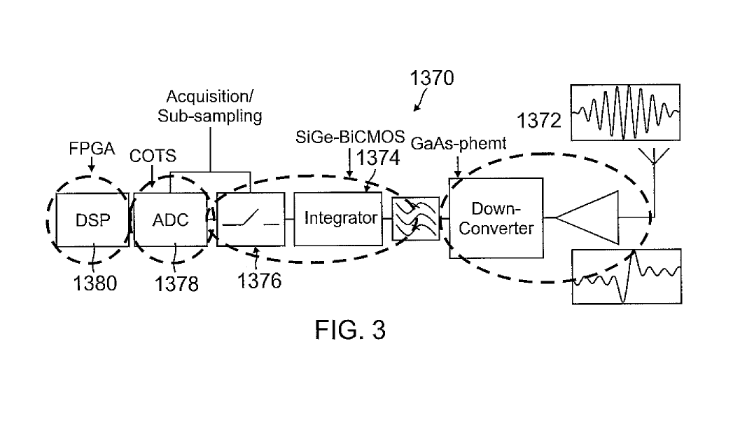

FIG. 3 is a system block diagram illustrating a radar receiver for the sensor of FIG. 1, in accordance with an embodiment.

FIG. 3 illustrates a radar receiver front-end 1370 for the radar sensor 1300 of FIG. 1, in accordance with an embodiment. Either type (as shown in FIG. 2A or 2B) of the transmitted pulse 1356 or 1366 may be received by the radar receiver front-end 1370. The amplified (and down-converted 1372) received signal is integrated 1374 to increase the signal to noise ratio (SNR). A sub-sampling track and hold circuit 1376 is used to create the “base-band” or “low-IF” signal. An analog to digital convertor (ADC) 1378 creates the digital representation of the base-band signal and forwards the data streams to digital signal processing (DSP). Due to the wide-band character of the analog RF signals, the filters as well as the custom made high frequency circuits of the receiver may be designed with constant group-delay.

As indicated in FIG. 3, the ADC 1378 may be implemented from commercially available components, also referred to as commercial-off-the-shelf (COTS) and the DSP 1380 may be implemented using field programmable gate array (FPGA) technology. As indicated in FIG. 3, implementation of radar receiver front-end 1370 may also employ, as with the implementation of the radar sensor 1300 transmitter, silicon-germanium SiGe BiCMOS technologies and GaAs pHEMT technologies.

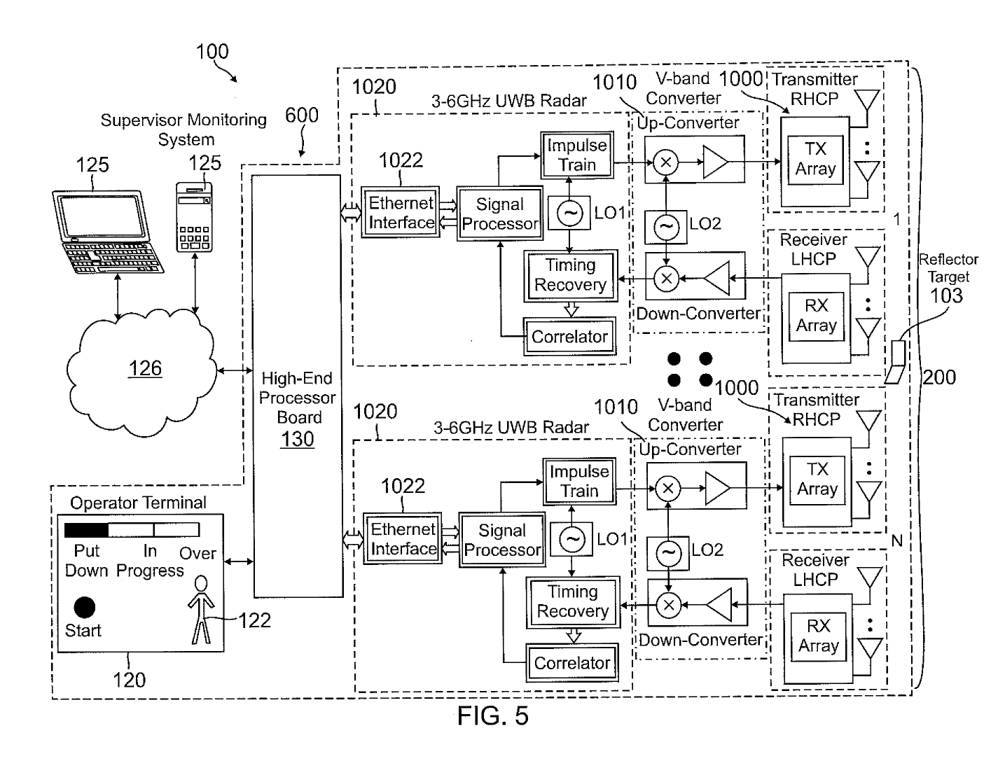

FIGS. 4A and 4B illustrate deployment of a wafer scale sensor system 1300, in accordance with one or more embodiments. By providing a fully integrated, solid state screener implemented, for example, using radar sensor 1300 described above or radar scanning system 100 described in FIG. 5, screening 400 can be installed in or at the entrance 402 of a security sensitive building 404, as shown in FIG. 4A, for example, or in a passage area (not shown) to a secured area such as airports, stadiums, banks, government offices, polling lines, or markets. Because of the compact nature (that does not rely on a mirror, focal array, or chopper as in conventional terahertz systems) of such a fully integrated, solid state screening system 400, the installation can be unobtrusive as seen in FIG. 4A and can even be placed covertly, such as inside an office's dry wall as shown in FIG. 4B.

FIG. 5 is a circuit block diagram showing an example of an implementation for a terahertz wafer scale radar sensor scanning system 100, in accordance with one or more embodiments. Each channel (e.g., each transceiver 1000 using UWB radar of primary processing unit 1020 as intermediate frequency (IF) and up- and down-converters of RF module 1010 in RF) may gather its own coded impulse trains with very high orthogonal suppression. Furthermore, a system of polarized transmitter-receiver arrays implemented in wafer scale technology for beam forming may also be included as part of scanning system 100, Scanning system 100 may use high bandwidth 10-300 GHz transmitters (e.g., transmitter portion of transceivers 1000) that can provide range resolutions as fine as 15 millimeters (mm) to 0.5 mm. Alternatively each receiver array (e.g., receiver portion of transceivers 1000) may be made of a detector material with near 100% absorption coefficient such that substantially the entire signal (e.g., pulse 1356 or 1366 shown in FIGS. 2A, 2B or reflected signal 1372 shown in FIG. 3) is absorbed. The panel array 200 enables very narrow beam formation. As an example, at about 1.0 THz, a 64×64 element wafer scale antenna array may measure 19 mm per side with a beam width of less than 1.0 degree. Additional beam narrowing and side lobe suppression may be achieved by using highly transparent collimator arrays.

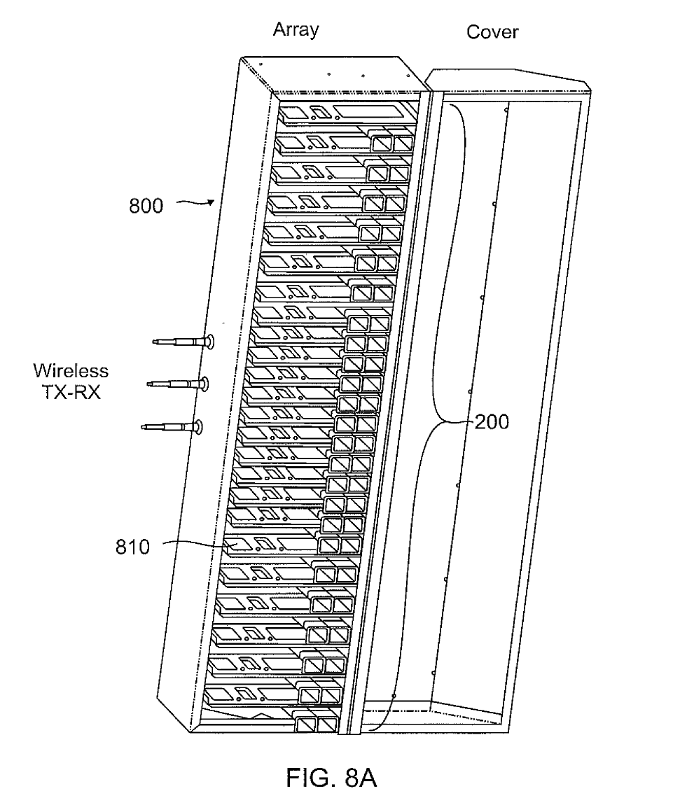

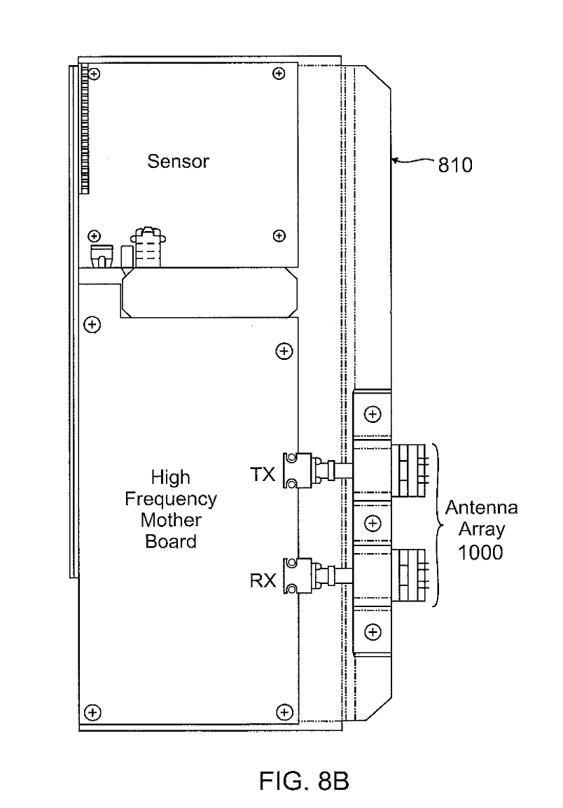

Scanning system 100 may include a number, N, (referred to as “channels”) of radar transceivers, such as radar transceivers 1000 illustrated in FIG. 5. N may be any number of channels. For example, N may be 24×3=72 radar transceivers 1000 for the embodiment described in FIG. 4A, N may be 64 channels for the embodiment shown in FIG. 4B, or N may be 24 for the modular unit described in FIG. 8A. Scanning system 100 may use an array of transceivers 1000 in which each transceiver is a single-chip radar transceiver realized in complementary metal oxide semiconductor (CMOS) process that may reduce the cost, weight, and energy consumption of system 100 compared to multi-chip radar transceiver implementations, may provide a set of completely isolated transceivers 1000 for system 100, may provide modularity of the system, and may facilitate extension of its application to medical diagnostic scanning.

In one or more embodiments, the system 100 may employ a either a linear (e.g., 1×n) or rectangular array (e.g., m×n, panel array 200) including one or more sets of multiple single-chip radar transceivers mounted on low dielectric material and a single FR4 substrate holding motherboard printed circuit board. In one embodiment, a multiple number of the single-chip radar transceiver boards may be integrated to implement an N-channel linear array for rapid millimeter-wave scan of the subject 105. One of the transceivers may be used as a transmitter and all of the multiple (for each board) or N transceivers may be used as receivers. The transmitted pulse may be, for example, a first order Gaussian pulse with a center frequency of 4.35 GHz and a bandwidth greater than 2.5 GHz. The receivers may use a sampling on a continuous time binary value to achieve a sampling rate equivalent to 40 giga-samples per second (GS/s).

Each transceiver 1000 may be connected via an Ethernet interface 1022 or USB or other ultra high speed interface with a processor 130 that may, for example, perform processing that combines data from all transceivers 1000—whether in a rectangular array or a linear array that is moved to scan the scanning area defined by panel array 200—to provide an image, such as image 122, on a display 120. System 100 may also include a supervisor monitoring system 125 that may communicate with processor 130 via a network 126, as shown, which may include a private secure network, for example, or the Internet.

In system 100, an array of independent transceivers 1000 (using UWB radar of primary processing unit 1020 as intermediate frequency (IF) and up- and down-converters of RF module 1010 in RF) may be used for extreme near-field imaging, In FIG. 5, an arrangement with an integrated IF (radar) board for each transceiver 1000 may operate at 1-10 GHz bandwidth. Results from a mathematical model of system 100 incorporating the inter-sample delay variations show that process variations are a strong influence on image degradation and a factor that is not easily rectified. In one or more embodiments, the problem of inter-sample delay variations may be addressed by direct calibration of the system 100 using one or more reflectors 103 (also referred to as a calibration target) positioned at known locations in the image.

FIG. 6 illustrates an actual image of a scan at 60 GHz of a dressed up mannequin with metallic joints simulating a person with a backpack and carrying a concealed, 3-inch, metal knife 601 in a pocket, used to test a scanning system 100 in accordance with one embodiment. For the test, a 48 sensor array (e.g., system with 48 channels) was used to scan vertically to extract the image in less than 3 seconds. The beam width of each of the 48 sensors used in the test was about 4 degrees (corresponding to a flat, ultra wideband 16×16 array with RHCP capability).

Implementation of the sensor array 200 may be achieved using integrated components such as radar on-a-chip and a TX-RX chip set that includes up-converter and down-converter, and gain stages. The feed network for sensor array 200 may be implemented using very low permittivity substrate or highly porous glass.

FIGS. 7A and 7B are illustrations of a mannequin simulating a person carrying a gun and knife, which are concealed in the pants of a mannequin as shown in FIG. 7A and visible, as shown in FIG. 7B with arrows to correspond the positions of the gun and knife to their concealed locations in FIG. 7A. FIG. 7C shows a scanned image of the gun 701 and a scanned image of the knife 702 at 60 GHz, in accordance with one embodiment. The resolution of the image can be enhanced by more than 30% per side at 94 GHz. FIG. 7C demonstrates ability of the screener, scanning system 100 to detect the gun when placed flat to the scantier (larger cross section) as well as the capability of detecting the knife as shown in FIG. 7C. The closer proximity to the scanning system 100 and the fact that the gun was flat to the antenna plates (e.g., presenting its largest cross section to panel sensor array 200) can make a perceptible difference in the quality of the image produced on the display.

FIG. 8A is an illustration of a 24-channel integrated radar module 800 for a scalable array for V-band or W-band to terahertz array implementation, in accordance with one or more embodiments; and FIG. 8B is an illustration of a channel line card as seen in the illustration of FIG. 8A, in accordance with one or more embodiments. In one embodiment, for example, three of the 24-channel modules 800 may be positioned end-to-end (e.g., stacked) employing 72 channels so as to cover the total height of a typical person. Each channel, as implemented on a channel line card 810 as shown in FIG. 8B, may be coded differently from all the other channels to enable rejection of scattering that distorts the final image. Line card 810 for each channel can be modular such that only the final TX-RX chip set (e.g., transceiver 1000) needs to be replaced for scaling from V-band to W-band and beyond to terahertz bands. Thus, scaling using the modularity of line cards 810 can be made relatively easy with no need for SWR (standing wave ratio) and lower level hardware modifications.

Embodiments described herein illustrate but do not limit the disclosure. It should also be understood that numerous modifications and variations are possible in accordance with the principles of the present disclosure. Accordingly, the scope of the disclosure is best defined only by the following claims.

What is claimed is:

1. A system comprising:
a plurality of radar transceivers disposed in an array, wherein:
the plurality of radar transceivers operate in a terahertz frequency band; and
the plurality of radar transceivers is configured to scan a subject within a walk-in scanning area;
a processor in communication with the plurality of radar transceivers, wherein the processor is configured to:
process image data from each of the plurality of radar transceivers;
combine the image data from the plurality of radar transceivers into a single image of the subject.

2. The system of claim 1, wherein one of the plurality of radar transceivers includes:
an antenna array comprising a plurality of antenna elements;
a feed network connecting an ultra wideband (UWB) signal to each of the antenna elements; and
a plurality of amplifiers dispersed in the feed network and configured to provide spatial power combining and beam forming of the UWB signal.

3. The system of claim 1, wherein:
a transmitter of the plurality of transceivers provides a range resolution in the range of 15 millimeters (mm) to 0.5 mm.

4. The system of claim 1, wherein:
a transceiver of the plurality of transceivers includes a 64×64 element wafer scale antenna array measuring less than 20 mm per side.

5. The system of claim 1, wherein:
a transceiver of the plurality of transceivers includes a 64×64 element wafer scale antenna array operating in the terahertz frequency band with a beam width of less than 1.0 degree.

6. A method for detecting concealed objects, comprising:
scanning a subject within a walk-in scanning area that places the subject within radar range of a plurality of radar transceivers operating in a terahertz frequency band;
processing image data from the plurality of radar transceivers;
combining the image data from the plurality of radar transceivers into a single image of the subject.

7. The method of claim 6, further comprising:
transmitting a radio frequency (RF) signal comprising an ultra wideband (UWB) pulse that is either a carrier-inclusive UWB-pulse or a carrier-less UWB-pulse;
receiving a reflection of the UWB pulse RF signal at the plurality of radar transceivers.

8. The method of claim 6, wherein:
operating in the terahertz frequency band provides a range resolution in the range of 15 millimeters (mm) to 0.5 mm.

9. The method of claim 6, wherein:
operating in the terahertz frequency band enables a transceiver of the plurality of transceivers to transmit with a beam width of less than 1.0 degree.

10. A walk-through scanning station comprising:
a modular array of radar transceivers including a plurality of scalable line cards, wherein each line card includes a radar transceiver configured to operate at V-band, W-band, or a terahertz frequency band;
a walk-in scanning area configured for a subject to pass within radar range of the modular array;
an image processor in communication with the modular array; and
a display in communication with the image processor for displaying an image of the subject scanned by the modular array of radar transceivers.

11. The scanning station of claim 10, wherein:
the image processor is in communication with a plurality of radar transceivers of the modular array; wherein the image processor is configured to:
process image data from each of the plurality of radar transceivers; and
combine the image data from the plurality of radar transceivers into a single image of the subject.

12. The scanning station of claim 10, wherein the radar transceiver includes:
an antenna array comprising a plurality of antenna elements;
a feed network connecting an ultra wideband (UWB) signal to each of the antenna elements; and
a plurality of amplifiers dispersed in the feed network and configured to provide spatial power combining and beam forming of the UWB signal.

13. The scanning station of claim 10, wherein:
a transmitter of the radar transceiver provides a range resolution in the range of 15 millimeters (mm) to 0.5 mm.

14. The scanning station of claim 10, wherein:
the radar transceiver includes a 64×64 element wafer scale antenna array measuring less than 20 mm per side.

15. The scanning station of claim 10, wherein:
the radar transceiver includes a 64×64 element wafer scale antenna array operating in the terahertz frequency band with a beam width of less than 1.0 degree.
